(19) United States
(12) Patent Application Publication
(10) Pub. No.: US 2011/0167997 A1
(43) Pub. Date: Jul. 14, 2011

(54) Up-armoring structure and method

(75) Inventors: Thomas S. Ohnstad, Salem, OR (US); Russell A. Monk, Salem, OR (US)

(73) Assignee: High Impact Technology, L.L.C.

(21) Appl. No.: 11/527,941

(22) Filed: Sep. 26, 2006

Related U.S. Application Data
(60) Provisional application No. 60/721,365, filed on Sep. 27, 2005.

(51) Int. Cl. F41H 5/04; B32B 37/02; B32B 37/14

(52) U.S. Cl. 89/36.02; 156/60; 89/904; 89/917; 89/910; 89/906; 89/907; 89/914; 89/915; 89/912; 89/920

(57) ABSTRACT

Up-armoring structure for protecting a selected surface including (a) a foundation layer formed of a chemically curable, elastomeric, urethane-based material applied to that surface, (b) a core layer of hardened armoring material embedded, at least partially, in the foundation layer, and (c) a coating overlayer of a chemically curable, elastomeric material which covers the core layer, and which is bonded molecularly to the foundation layer. The method of the invention includes (a) applying a chemically curable, elastomeric foundation layer to a surface which is to be armor protected, (b) embedding a core layer of hardened armoring material at least partially in the foundation layer, (c) creating over the core layer an overlayer of chemically curable, elastomeric material, and (d) molecularly bonding the coating layer to the foundation layer.

### CROSS REFERENCE TO RELATED APPLICATION

This application claims priority to the filing date of currently pending U.S. Provisional Patent Application Ser. No. 60/721,365, filed Sep. 27, 2005 for “Up-Armor Method and Structure”. The entire disclosure content of that prior-filed U.S. Provisional Patent Application is hereby incorporated herein by reference.

### BACKGROUND OF THE INVENTION

This invention relates to an up-armoring structure and methodology, and in particular, to such subject areas that are associated with surface-protecting various structures which might become targets for an explosive blast and/or a projectile attack, such as a bullet attack. Such attacks, unfortunately, are marks of unsettled times, such as now, in which random acts of terrorism form daily threats in many regions of the world.

### SUMMARY OF THE INVENTION

In this setting, we propose the mentioned up-armoring structure and methodology which allows for rapid, effective and efficient application of a castable, layered armor to various kinds of surfaces requiring protection against events like those mentioned above. In particular, the structure and methodology of this invention enable quick preparation and application, to a relatively wide variety of surfaces, such as fuel-container surfaces, building surfaces, vehicle surfaces, bridge-structure surfaces, and other surfaces, of a specially constructed, plural-layered armoring structure, referred to herein as a castable armoring structure. In general terms, this armoring structure includes a core layer of hardened armoring material which is fully jacketed, i.e., fully enveloped and encapsulated, by a high-elastomeric material preferably formed of a chemically curable, sticky, urethane-based castable material disposed so as to create spaced, outer surface layers, or expanses, which are located on opposite sides of the core layer material in, effectively, an embedding/embedded cooperative relationship with that core material. Preferably, the elastomeric material chosen is one which, when exposed to a liquid such as hydrocarbon (petroleum-based) fuel, exhibits liquid-imbibing behavior that creates layer swelling and expansion.

In the practice of the invention, layered up-armoring structures are prepared and shape-formed as a part of the process of applying them to the specific surfaces which they are intended to protect. Chemically curable elastomeric material of the type mentioned above is first applied as a properly shaped tacky mass layer to a selected region of a surface which is to be protected. While this elastomeric layer is still uncured, other material, or materials, chosen to form a hardened armoring core layer, are partially embedded in this mass, and then another, second tacky mass of preferably, though not necessarily, the same chemically curable elastomeric material is applied over the partially embedded core material to form a full jacket of elastomeric material around the core, with perimeter portions of the two tacky mass layers contacting and molecularly bonding with one another.

Because of the ease with which this kind of a layer structure may be shaped and formed, and recognizing that the two jacketing, elastomeric layers are flowable up to a point near full chemical curing, we refer to the resulting structure as a castable structure. The layer of elastomeric material which directly contacts the to-be-protected surface bonds tenaciously to that surface, and all of the employed elastomeric material cures without any need for open atmospheric (air) exposure.

Various materials, including hardened steel, ceramics, and aramid-fibre fabrics, may form the mentioned hardened armoring core layer, and this layer may be constructed specifically, if desired, with various combinations of these kinds of armoring materials.

While all of the armor-protecting behaviors of the uniquely applied and formed layered structure of this invention are not necessarily fully understood, there appears to be a significant armoring advantage gained by virtue of the fact that a hardened core-layer armoring material is jacketed by elastomeric material which aids in the act of protecting the subject surface against a blast or projectile attack. Where this elastomeric material is one which has a liquid-imbibing affinity for hydrocarbon fuel, even further advantages are gained when the structure of this inventions is employed on the outside of a wall in a hydrocarbon fuel container. Under such a circumstance, if and when a blast and/or a projectile attack event causes a puncture wound to occur, exposing contained fuel, resulting fuel leakage triggers a liquid imbibing behavior in the engaged elastomeric material, which then responds by working extremely quickly to self seal against any major liquid leakage.

These and various other features and advantages that are attained by the invention will become more fully apparent as the description which now follow is read in conjunction with the accompanying drawings.

### DESCRIPTION OF THE DRAWINGS

FIG. 1 is a simplified fragmentary plan view of one form of castable, layered up-armoring structure made in accordance with practice of the present invention. Certain portions are broken away to reveal details of the relevant layer structure, and to expose an included, central armoring layer structure.

FIG. 2 is a fragmentary cross section taken generally along the line 2-2 in FIG. 1.

FIGS. 3, 4 and 5 are simplified, fragmentary, cross-sectional views each illustrating different modified forms of a central armoring layer structure useable alternatively in the layered arrangement pictured in FIGS. 1 and 2.

FIG. 6 is a simplified, fragmentary, schematic, side elevation of a portion of vehicle door structure which includes up-armoring structure made in accordance with the invention.

FIG. 7 is a simplified, fragmentary, schematic, isometric view of a roadway bridge, the underside of which is covered with up-armoring structure made in accordance with the invention.

FIG. 8 is a large-scale, fragmentary illustration of the upper, domed end of a cylindrical structure, which end has been protected by the application thereto of a form of the up-armoring structure of this invention which includes a plurality of perimeter-overlapping, generally circular/annular, hardened armoring core rings.

FIG. 9 is a fragmentary, lateral elevation further illustrating details at the up-armoring structure pictured in FIG. 8.

FIG. 10 is similar to FIG. 8, except that it shows here an up-armoring structure in which circular/annular, perimeter-overlapping, hardened core armoring materials are employed wherein the annular-armor, ring-like components have a frustro-conical configuration.

FIG. 11 relates to FIG. 10 in the same manner that FIG. 9 relates to FIG. 8.

### DETAILED DESCRIPTION OF THE INVENTION

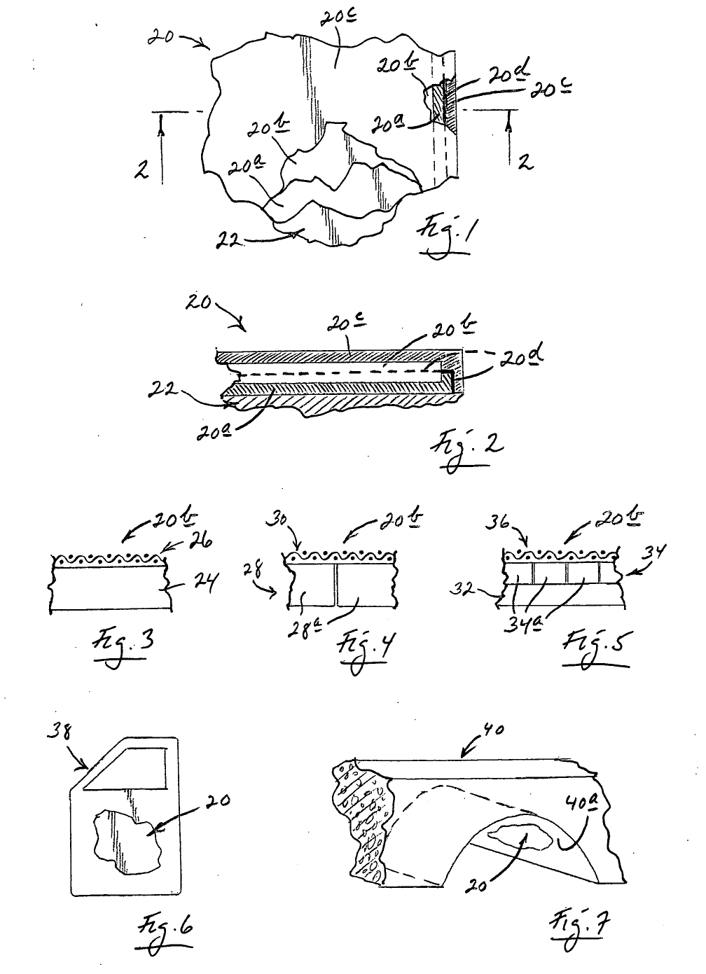

Turning now to the drawings, and beginning first of all with FIGS. 1-5, inclusive, indicated generally at 20 in FIGS. 1 and 2 is a preferred embodiment of up-armoring structure made in accordance with practice of the present invention. A surface structure which is protected by up-armoring structure 20 is shown generally at 22, with up-armoring structure 20 including a chemically curable, elastomeric foundation layer 20a, a core layer 20b of hardened armoring material partially embedded with one of its faces lying in layer 20a, and a chemically curable, elastomeric coating layer 20c which is distributed over the opposite face of core layer 20b, and which joins, especially around the perimeter of the core layer, with foundation layer 20a through a molecular bond shown generally at 20d. In this up-armoring layer arrangement, core layer 20b is essentially fully embedded within the fully surrounding “jacket” which is formed essentially by layers 20a, 20c and bond 20d.

In the preferred embodiment of the invention, prepared in accordance with a preferred manner of practicing the invention, elastomeric layers 20a, 20c are made of the same material which takes the form of what is referred to as a castable, chemically curable urethane material formed from two starter materials one of which typically is a resin material and other of which is typically an activator. A product which has been found to be very satisfactory for use in the practice of this invention with regard to layers 20a, 20c is a castable urethane product sold under product number VFI-3039 made by Volatile Free, Incorporated, located in Brookfield, Wis. Another useful material is sold under the trademark TUFF STUFF®FR made by Rhino Linings USA, Inc., a company based in San Diego, Calif.

In the cases of each of these two different kinds of castable urethane materials, and as has been stated above, the relevant, two-part blended materials cure chemically without the need for being exposed to air, and thus are extremely useful in confined spaces where air exposure is minimal or nil. Preferably, the urethane material selected for use, once appropriately blended to begin its curing process, has the consistency of thickened, flowable honey.

In the practical implementation of the invention, a foundation layer 20a is first prepared from this blended urethane material, preferably with a layer thickness residing somewhere in the range of about 1/16-inches to about ¼-inches.

Immediately following the initial preparation of a selected, to-be-protected surface area with such a foundation layer, and recognizing that this foundation-layer material is a very tacky and sticky material which begins to bond tenaciously to the receiving surface, and to cure relatively quickly, an appropriate core layer of hardened armoring material to form core layer 20b is pressed into place in the foundation layer to become partially embedded in that layer, somewhat as illustrated in FIG. 2 in the drawings. In FIG. 2, hardened armoring material layer 20b takes the form of a single layer of appropriately hardened steel with a thickness of about 1-inches.

FIGS. 3, 4 and 5 show, respectively, three, different, selectively alternative forms, or constructions, for layer 20b which are appropriate to different up-armoring applications. FIG. 3 shows a hardened armor material layer which includes a sub-layer 24 of hardened steel, such as that just mentioned, and an additional sub-layer 26 of a woven aramid fibre material. FIG. 4 shows a hardened armoring core layer which is made up also of two sub-layers 28, 30, with sub-layer 28 being formed from a plurality of side-by-side adjacent ceramic tiles, such as those shown at 28a, and with sub-layer 30 being formed of the same type of woven aramid fibre fabric material pictured at 26 in FIG. 3. FIG. 5 illustrates a hardened armoring core layer which includes three sub-layers, 32, 34, 36. Sub-layer 32 herein is formed of hardened steel, such as that mentioned earlier, sub-layer 34 of plural ceramic tiles, such as tiles 34a, which are like previously mentioned tiles 28a, and sub-layer 36 is formed of essentially the same kind of aramid fibre woven fabric present in previously mentioned sub-layers 26, 30.

It is of course possible to form the hardened armoring core layer of this invention in ways other than those specifically illustrated in FIGS. 2-5, inclusive, with different specific materials, and with different numbers of sub-layers organized differently than those which are shown, for example, in FIGS. 3-5, inclusive. In each case, the hardened armoring core material is, during the formation of up-armoring structure 20, pressed at least partially into initially prepared foundation elastomeric layer 20a to establish a partially embedded condition for such a core material.

Following partial embedding of core layer 20b as just outlined, elastomeric overlayer 20c is formed over the combination of layers 20a, 20b, overlapping at least around the perimeter of core layer 20b to form a molecular bond, such as bond 20d, between the two elastomeric layers. Preferably, the thickness of overlayer 20c, where it lies above core layer 20a, is in the range of about ⅛-inches to about 1-inches.

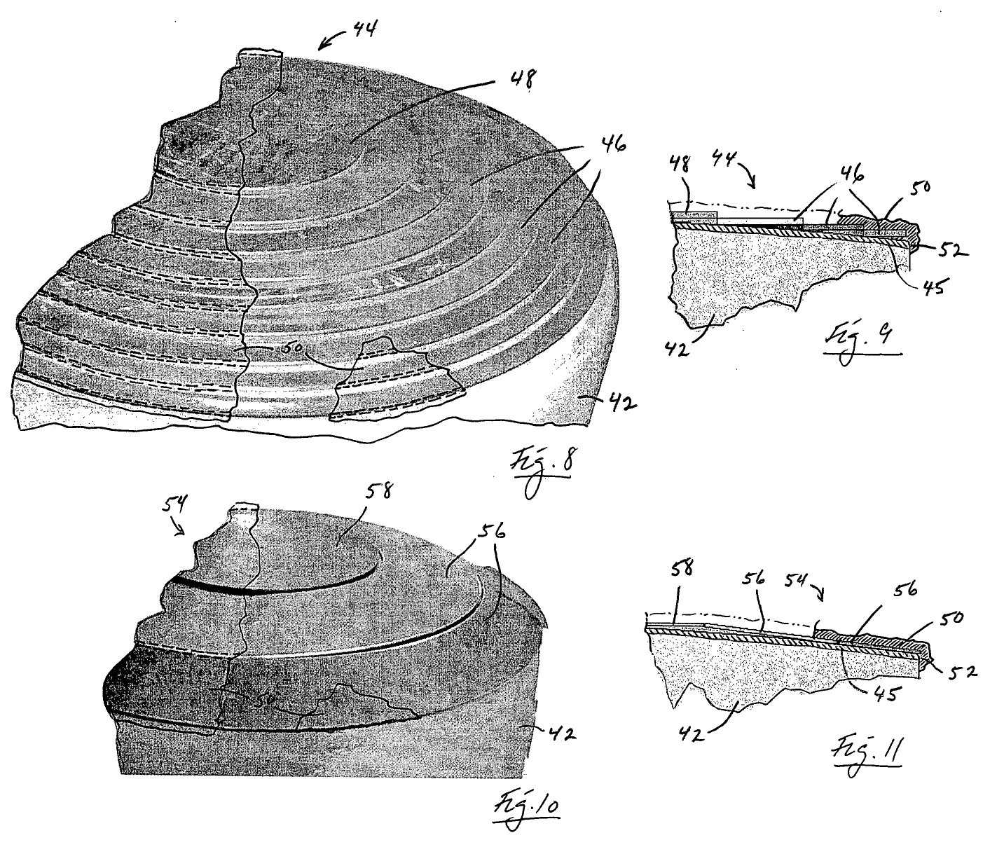

The fully formed up-armoring structure which, as will be apparent to those skilled in the art, is easily formed in place and in the field, if so desired, where up-armoring is desired, can be created very quickly and easily, with the elastomeric layer material curing fully in a chemical way without the need for exposure to air. The resulting up-armoring structure has proven to be an extremely effective shield structure for a variety of to-be-protected other structures, such for a vehicle door structure like that shown generally, fragmentarily and schematically at 38 in FIG. 6, and for the underside tunnel portion of a bridge structure, such as the tunnel portion 40a shown for a bridge 40 which is pictured generally, fragmentarily and schematically in FIG. 7.

For reasons which are not fully understood, a blast or ballistic attack launched in the vicinity of up-armoring structure 20 is stoutly and impressively resisted by this structure, with core layer 20b providing what can be thought of as the backbone of threat resistance, disposed, as it is, in a kind of “floating” condition within the fully surrounding jacketing enclosure formed by the foundation and coating layers of elastomeric urethane material.

Obviously, the overall configuration of up-armoring structure 20 can be varied with a great deal of versatility to suit different applications, particularly in the sense that the hardened armoring core layer may either be formed as a singular material, or as an arrangement of sub-layers including one or more different materials organized in different relative-disposition fashions.

Turning attention especially now to FIGS. 8-11, inclusive, FIGS. 8 and 9 are related to one another, and such also is true with respect to FIGS. 10 and 11. In particular, FIG. 8 shows a fragmentary portion of the end of a cylindrical, domed container 42 which is intended to be protected by up-armoring structure made in accordance with the present invention. This very same cylindrical, domed-end container is also shown in FIGS. 10 and 11.

In FIGS. 8 and 9, up-armoring structure made in accordance with a modified form of the invention is shown generally at 44. Structure 44 herein includes a foundation layer 45 (see FIG. 9), which is very much like previously described elastomeric urethane foundation layer 20a seen in FIGS. 1 and 2, at least partially embedded in which foundation layer (45) is a perimeter-overlapping stack of annular, hardened steel rings 46 which extend to a central, circular plate 48 that lies substantially centered along the long axis (not shown) of cylindrical symmetry of container 42.

Formed as an overlayer which completely coats and encloses this ring and circular-plate armoring core layer is a coating overlayer 50 of the same elastomeric urethane material employed in foundation layer 45. As can be seen in FIG. 9, elastomeric layers 45 and 50 join one another through a molecular bond 52 which extends essentially around the perimeter of the domed end of cylinder 42, immediately outwardly of the perimeter of the outermost armoring core ring 46.

The up-armoring structure pictured in FIGS. 10 and 11, which is generally designated 54, is similar in many respects to up-armoring structure 44 shown in FIGS. 8 and 9, with the exception that the hardened armoring core layer is formed from rings and a central circular plate, 56, 58, respectively, with rings 56 having an annular, generally frustro-conical configuration.

In the structure illustrated in FIGS. 10 and 11, the foundation and coating overlayer elastomeric urethane layers are substantially the same as their counterparts pictured in FIGS. 8 and 9, and are given, therefore, the same reference-numeral designators. Also, where these foundation and coating layers join around the periphery of the upper end of container 42, they join one another through a molecular bond which, as in FIG. 9, is also designated with the reference numeral 52.

An up-armoring structure has thus been described which is formed of a foundation layer and coating overlayer of castable elastomeric urethane material which can be cured chemically to promote its use in many different kinds of locations, with an included, embedded, hardened armoring core layer that may be formed of a variety of different singular or plural armoring materials, such as hardened steel, ceramic tile, and aramid fibre woven fabric. While, with respect to FIGS. 8-11, inclusive, only hardened steel armoring core material is illustrated, it should be understood that this material may be replaced by any of the other hardened core armoring materials suggested herein.

It will be evident that it is a relatively simple matter to provide up-armoring protection for a variety of different structures, with resulting up-armoring construction being easily formed to take on whatever appropriate shape is necessary to provide the desired protection. The use of castable elastomeric urethane which is chemically curable helps to promote the ease of formation and implementation of up-armoring in accordance with practice of the invention, and it will be very apparent that up-armoring can, accordingly, take place even in what may be thought of as “out-in-the-field” conditions.

From the point of view of methodology, that of the present invention can be thought of as including the steps of (a) applying a chemically curable, elastomeric foundation layer to a surface which is to be armor protected, (b) embedding, at least partially, a core layer of hardened armoring material in the foundation layer, (c) creating a coating layer (an overlayer) of chemically curable, elastomeric material over the core layer, and (d) bonding the coating layer to the foundation layer. Preferably, the bonding step is performed in a manner which forms a molecular bond between the prepared foundation layer and the prepared coating layer.

Accordingly, while several modifications and manners of practicing the invention have been illustrated and described herein, it is appreciated that variations and modifications may be made, and it is intended that all such variations and modifications which come to the minds of those generally skilled in the relevant art will be construed to come within the scope of the below claims to invention.

We claim:

1. A surface up-armoring method comprising
applying a chemically curable, elastomeric foundation layer to a surface which is to be armor protected,
embedding, at least partially, a core layer of hardened armoring material in the foundation layer,
creating a coating layer of chemically curable, elastomeric material over the core layer, and
bonding the coating layer to the foundation layer.

2. The method of claim 1, wherein said bonding takes the form of molecular bonding.

3. The method of claim 1, wherein each of said applying and creating steps is performed utilizing a sticky, flowable, castable, urethane-based material.

4. Up-armoring structure for protecting a selected surface, in operative condition comprising
a foundation layer formed of a chemically curable, elastomeric, urethane-based material applied to the selected surface,
a core layer of hardened armoring material embedded, at least partially, in said foundation layer, and
a coating overlayer of a chemically curable, elastomeric material which covers said core layer, and which is bonded to said foundation layer.

5. The structure of claim 4, wherein the bond which exists between said coating overlayer and said foundation layer is a molecular bond.

6. The structure of claim 4, wherein the material which forms said foundation layer exhibits liquid-imbibing behavior that creates foundation-layer swelling and expansion on contact with hydrocarbon fuel.

7. The structure of claim 6, wherein the material which forms said coating overlayer exhibits liquid-imbibing behavior that creates coating-overlayer swelling and expansion on contact with hydrocarbon fuel.

8. The structure of claim 4, wherein each of said foundation layer and said coating overlayer is formed of a sticky, flowable, castable, urethane-based material.

9. The structure of claim 8, wherein the material which forms said foundation layer exhibits liquid-imbibing behavior that creates foundation-layer swelling and expansion on contact with hydrocarbon fuel.

10. The structure of claim 9, wherein the material which forms said coating overlayer exhibits liquid-imbibing behavior that creates coating-layer swelling and expansion on contact with hydrocarbon fuel.

11. The structure of claim 4, wherein said hardened armoring material takes the form of hardened steel.

12. The structure of claim 4, wherein said hardened armoring material takes the form of a ceramic tiles.

13. The structure of claim 4, wherein said hardened armoring material takes the form of aramid-fibre fabric.

14. The structure of claim 4, wherein said hardened armoring material includes a cooperative combination of hardened steel, of ceramic tiles, and of aramid-fibre fabric, distributed each in layer form.

15. The structure of claim 4 which is intended for use on a generally circularly perimetered, domed end of a cylindrical structure, and wherein said hardened armoring material core layer takes the form of plural, perimetrally overlapping, generally concentric, annular ring elements.

16. The structure of claim 15, wherein said ring elements are planar in nature.

17. The structure of claim 15, wherein said ring elements are frustro-conical in nature.

18. Up-armoring structure in the form generally of a planar, plural-layer assembly for protecting a selected structural surface comprising
a core layer of hardened armoring material having opposite faces, and
an elastomeric, chemically cured jacket enclosing said core layer, and including a pair of spaced, molecularly co-bonded outer layers disposed on said core layer's said opposite faces, adapted for effecting the pre-cure, self-sticky adherence of one of said outer layers to a selected structural surface which is to be protected, thus to attach the up-armoring structure to that selected surface.
